(19) United States
(12) Patent Application Publication
(10) Pub. No.: US 2010/0101737 A1
(43) Pub. Date: Apr. 29, 2010

(54) Filter Assembly Containing Metal Fibre Filter Elements

(76) Inventors: Filip René Irena Kiekens, Geel (BE); Kristof Juliette Gustaaf Tersago, Beerse (BE)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 12/531,134

(22) PCT Filed: Mar. 14, 2008
(86) PCT No.: PCT/EP08/53098

§ 371 Date: Sep. 14, 2009

(30) Foreign Application Priority Data
Mar. 15, 2007 (EP) 07104278.2

(51) Int. Cl. B01D 46/24; B01D 1/18; B01D 39/20

(52) U.S. Cl. 159/4.2; 96/229; 95/281

(57) ABSTRACT

The present invention relates to a self-cleanable filter assembly capable of filtering small particles from a gas stream, the use of one or more metal fiber filter elements in said filter assembly, use of said filter assembly in a spray-dryer installation. The invention further relates to a system for cleaning the filter assembly, a method of cleaning the filter assembly and the filter elements contained therein, and a spray dryer installation comprising the filter assembly of the present invention.

The present invention relates to a self-cleanable filter assembly capable of filtering small particles from a gas stream, the use of one or more metal fiber filter elements in said filter assembly, use of said filter assembly in a spray-dryer installation. The invention further relates to a system for cleaning the filter assembly, a method of cleaning the filter assembly and the filter elements contained therein, and a spray dryer installation comprising the filter assembly of the present invention.

High efficiency filtration of small particles from a gas stream is required in many different applications including pharmaceutical applications where gas streams carry active pharmaceutical ingredients (API). This is for instance the case in spray dryers. In a conventional spray-dryer installation, the hot drying gas is filtered by an inlet filter, such as for example a HEPA filter, and then introduced to the drying chamber via an air disperser, such as for example a ceiling air disperser. The nozzle, through which the feed is pumped and atomized, is placed in the drying chamber, such as for example in the centre of the air disperser, and facilitates atomization of feed. The drying gas leaves the chamber to a cyclone, where the spray-dried powder is separated and collected. Fine powder particles which are not retained in the cyclone are collected in a bag filter. The gas is then passing an outlet filter, such as for example a HEPA filter, and then optionally further conditioned, such as for example by leading it to a shell and tube condenser for cooling/condensing of solvent, and then back to the heater unit. For a schematic representation of a conventional spray-dryer installation, reference is made to FIG. 1.

As already indicated above, the function of the bag filter is to separate from the outlet gas the fine spray-dried powder particles which leave the cyclone via the outlet gas. The gas stream enters the cylindrical chamber of the bag filter and the fine powder particles are deposited on the outer-surface of the filter bags. The gas stream passes the filter medium and leaves the bag filter. By gravity or a reverse gas pulse, the particles fall to the bottom of the filter assembly or filter bag where they can be collected.

When using a spray dryer in the production of a pharmaceutical composition, meaning a composition comprising an active pharmaceutical ingredient or drug, it is important to reduce the exposure of personnel to the drug as much as possible. This implies that the amount of manipulations carried out by the operators has to be reduced as much as possible. Therefore, a spray dryer from which the filter bags in the bag filter can be cleaned-in-place, without the need to remove the filter bags from the apparatus and cleaning them outside the apparatus, is desirable. This process will also be less labor-intensive and more cost-effective.

In a spray-drying process, the vast majority of the spray-dried powder is collected under the cyclone (>99%) and only the very fine powder particles are collected as waste under the bag filter. However, for some applications, particles with a very small particle size are desired and are intentionally manufactured, e.g. powders for nasal sprays. Since these fine particles are not separated from the carrier-gas in the cyclone due to their low weight and density, they will be collected under the bag filter. If these particles are to be used as drugs, it is required that they are produced under GMP (Good Manufacture Practice). To comply with GMP guidelines, a filter assembly which can be cleaned in place and wherein dead spots (locations which can not appropriately be cleaned because they are difficult to reach) do not occur, is desired. Of course also high efficiency filtering (down to 0.2 micrometer) is desired.

Currently, none of the existing bag filters on the market for spray-dryers for pharmaceutical use, can be sufficiently cleaned in situ via an automated Clean-in-Place system. Systems for dry cleaning of a filter assembly are known. In these systems, a pulsed air jet is used : an air jet is directed into the interior of the filter element and each filter element is pulsed with a high-pressure air jet at regular time intervals. In this way the filter element vibrates and the cake of particles built up at the surface of the filter is periodically removed. This method of dry cleaning is also known as blowback. However, this dry cleaning may not be sufficient for complying with GMP guidelines for pharmaceutical products. Also wet cleaning in place is desired. Such a wet cleaning can be accomplished by applying a spraying device on top of the filter assembly which sprays liquid into the interior of the filter elements.

However, with the current filter assemblies on the market for spray dryer installations, the above dry and wet cleaning methods cause problems. For instance, with filter bags hanging in a filter-plate inside the bag-filter and being made of Goretex® and Teflon®, the filter bags vibrate in their caging when being cleaned with a blowback technique to such an extent that holes in the bags may develop. If the filter bags are wet cleaned via spraying a cleaning solution into the interior of the bag, the bag filter may rupture under the weight of the cleaning solution or can be detached from the top plate to which they are attached. An alternative for wet cleaning is opening of the bag-filter assembly, removing the filter-bags and washing them separately outside the filter assembly. This is a time-consuming process and there may be exposure of the personnel to the spray-dried powder containing drug. As indicated above, this method is not well suited to comply with GMP requirements for pharmaceutical products.

In order to comply with GMP guidelines, it is also important that no undesired substances can leak from the material from which the filter elements are made, since the filter elements are in contact with the spray-dried powder. This implies that the filter elements have to be resistant to organic solvents : the gas-flow, in particular the nitrogen-flow, which is re-circulated in the spray-dryer and which passes over the filter elements, usually contains high levels of organic solvents such as for example ethanol, methylenechloride, acetone, tetrahydrofuran and the like. The filter element material should be able to withstand the corrosive influence of these solvents.

The filter elements should also retain their filter performance, even after several cleaning cycles. The filter elements should also be resistant to the cleaning process (e.g. should not show rupture or oxidation during the cleaning process) and they should be resistant to the cleaning detergents.

Further criteria to which the filter elements should comply are:
Low pressure drop over the filter: the pressure drop over the filter should be low to avoid pressure build-up in the system; (the gas-flow depends on the size of the installation and it is within the skills of the expert to recognize the appropriate gas flow.
Temperature: the temperature of the gas-flow can be up to 180 degrees Celsius. The filter element material should be able to keep its integrity at these elevated temperatures.
Filter-efficiency: the filter element should be able to filter out powder particles out of the gas flow which have an average particle size ranging from 0.2 to 10 micrometer.
Pharma grade-quality (FDA approved materials).
High efficiency filtration (down to 0.2 micrometer).

The filter assembly as a whole should be fully cleanable, so all parts that come in contact with product should be fully cleanable in place and the system should be fully cleanable. This is needed to comply with GMP guidelines, e.g. to avoid that cross-contamination occurs where undesired products remain in the system during the next production batch. Systems for wet cleaning of a filter assembly wherein cleaning means, e.g. spray nozzles, are located above the filter elements or cleaning means are located at a fixed position in the interior of the filter element may result in suboptimal cleaning because not all regions within the filter element experience a sufficient impact of the cleaning liquid to be properly cleaned or not all regions can be reached by the cleaning liquid. The further the regions are removed from the spray nozzle, the lower the impact of the cleaning liquid and the more difficult it is to clean these regions.

Existing methods for wet cleaning can also cause pressure build-up in the system which makes them unsuitable methods for pressure-sensitive equipment.

The Goretex®-Teflon® filter bags conventionally used in the bag filter of a spray dryer installation are not well suited for the above indicated in situ GMP cleaning process e.g. because they are not resistant to the organic solvents used in a pharmaceutical spray drying process, because they do not withstand the gas flows used in a spray dry process with dry cleaning (inlet gas flow and blowback) and because they may rupture when filled with cleaning solution in a wet cleaning method.

We have now found that metal fiber filter elements comply with the above-indicated criteria and hence can be used in a filter assembly which has to comply with GMP requirements, such as filter elements for use in a bag filter of a spray dryer installation, in particular a spray dryer installation used in the production of a pharmaceutical composition, which can be cleaned in place according to GMP. By providing cleaning means which can move axially in the interior of the filter elements during cleaning, the efficiency of the cleaning process is increased because dead points do not occur and the whole interior surface of the filter element undergoes sufficient impact force of the cleaning liquid in order to provide appropriate cleaning.

Furthermore the use of bellows to provide movable cleaning means assures the integrity of the assembly during drying and cleaning. The filter assembly is guaranteed airtight. The use of separate cleaning liquid supply pipes and valves increases the efficiency of the cleaning.

The present invention therefore relates to a filter assembly containing metal fibre filter elements for filtering solid particles from a gas stream and which is cleanable in place. We have found that when applying cleaning liquid to the exterior side of these metal fiber filter elements containing the filtered particles, that this may cause the filtered particles to penetrate deeper into the filter (and hence being more difficult to remove). The filter assembly of the present invention avoids this problem by forcing cleaning liquid in reverse flow through the filter medium in regard to the normal gas stream. The impact force of the cleaning liquid is the main means of cleaning The product deposit on the filter is pushed off the filter from the inside thus giving a highly efficient cleaning.

By using cleaning means which can move axially in the interior of the filter elements during cleaning, the efficiency of the cleaning process is improved as indicated above but also pressure build-up in the filter assembly is reduced and therefore this way of cleaning is suitable for pressure-sensitive filter assemblies. This allows that the filter assembly is manufactured from materials with a reduced thickness, which reduces the cost of the filter assembly and supporting structure. Because the filter assembly can be made from materials with a reduced thickness, the assembly also requires less energy to be heated (by heating the filter assembly, condensation of the gas within the filter assembly is avoided).

By using the above approach, the filter assembly is cleanable in place, the whole system can be used both for filtering gas streams (normal operation) and cleaning of filters and filter housing (cleaning phase) without opening of the system thus allowing the filtration of toxic, aggressive or pharmaceutical materials.

### BRIEF DESCRIPTION OF THE FIGURES

FIG. 1 shows a schematic representation of a conventional spray dryer installation.

FIG. 2 shows an embodiment of a filter plate for securing filter elements into a filter assembly (diameter of the opening for the filter element indicated and thickness of the plate indicated) and a filter element (length indicated).

FIGS. 3A and 3B show a representation of a filter element with flange attached to a filter plate for securing filter elements into a filter assembly.

FIG. 4 shows a schematic representation of a circular header for three spraying means extending through the housing of the filter assembly.

FIGS. 5A and 5B show a vertical cross section of an embodiment of the filter assembly according to the present invention.

FIG. 6 shows a transverse cross section at the upper section, above the filter plate, of the filter assembly of FIGS. 5A and B.

FIG. 7 is a detailed vertical cross section of the cleaning means of FIG. 5B.

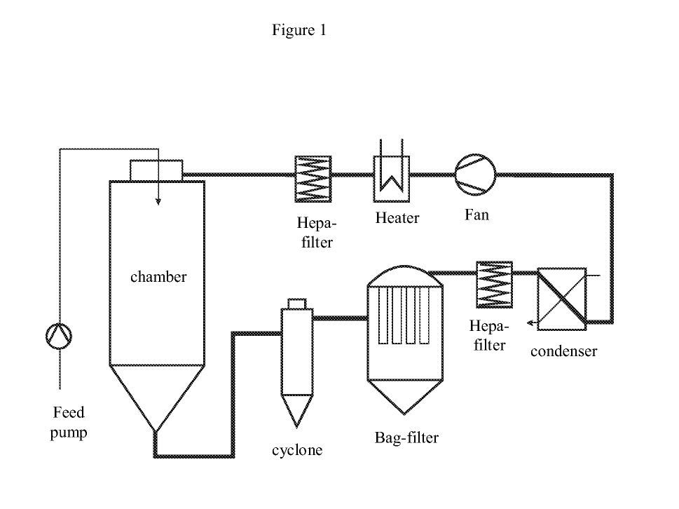

### DESCRIPTION OF BACKGROUND ART

U.S. Pat. No. 6,149,716 describes a filter unit having a plurality of filter elements extending from a plate. Cleaning in place of the filter elements is performed by supplying cleaning liquid in a sequence of several separate liquid pulses, which are mixed with the pressurized gas pulses.

U.S. Pat. No. 5,795,359 describes an apparatus for separating particulate or powdery material from an entraining gas including a tubular filter disposed between the gas inlet and outlet and mounted such that the gas must pass through the filter to reach the gas outlet. A washing device is provided which is disposed in an upper region of the filter and it includes nozzles connected to the end of a liquid supply pipe which extends coaxially or concentrically within a back flow gas supply pipe.

WO 01/03808 describes a filter bag comprising suspension means positioned inside the filter bag and comprising an elongate, tube-shaped, flexible outer skirt. There are provided means for applying a liquid to the interior of the filter bags comprising a movable arm provided with spray nozzles that successively are movable to positions above different filter bags.

### DETAILED DESCRIPTION OF THE INVENTION

The present invention relates to the use of one or more metal fiber filter elements in a filter assembly for filtering solid particles from a gas stream of a spray dryer installation, said filter assembly preferably being suitable for collecting and recovering spray-dried powder particles entrained in the outlet gas leaving the cyclone. These one or more filter elements are used to separate the spray-dried powder particles from the outlet air. The separated spray-dried powder particles preferably have an average particle size ranging from about 0.2 micrometer to about 10 micrometer, more in particular ranging from 0.5 micrometer to 1 micrometer.

The present invention also relates to a process for separating spray-dried powder particles from the outlet gas leaving the cyclone of a spray dryer installation by using one or more metal fiber filter elements, said filter elements being contained in a filter assembly of the spray dryer installation. The separated spray-dried powder particles preferably contain an active pharmaceutical ingredient and may be used further for the preparation of a medicament.

The present invention further relates to a filter assembly for use in a spray dryer installation comprising one or more metal fiber filter elements, said filter assembly preferably being suitable for collecting and recovering spray-dried powder particles entrained in the outlet gas leaving the cyclone.

A preferred embodiment of the present filter elements is stainless steel metal fiber filter elements, in particular sintered metal fiber filter elements. In particular, the filter elements of the present invention comprise Bekiflow® HG sintered metal fiber filter elements (Bekaert).

It is well-known to the skilled man what is meant by stainless steel metal fiber filter elements, in particular stainless steel sintered metal fiber filter elements. Filter material that will also fulfill the above-indicated criteria are high temperature resistant alloys, Nickel and Nickel alloys. Suitable materials are 316L stainless steel, Inconel 601, Alloy HR or Fecralloy.

The metal fiber filter elements used in the filter assembly of the present invention are preferably tubular or cylindrical and are preferably able to retain particles with an average particle size of about 0.2 micrometer or larger from a gas stream, thus the filter elements preferably retain particles with an average particle size of≧0.2 micrometer from a gas stream.

A particular embodiment of a metal fiber filter element of the present invention is a tubular or cylindrical metal fiber filter element wherein the bottom of said filter element also comprises filter medium. Thus the bottom of the filter element also comprises metal fiber filter material, such as for example Bekiflow® HG. Thus the side walls as well as the bottom of the cylindrical filter element are composed of metal fiber filter material. This increases the drainability of the filter element and makes it more suitable for use in a filter assembly, which has to be cleaned in place, such as a filter assembly or bag filter in a spray dryer installation, in particular a spray dryer installation used in the production of a pharmaceutical composition.

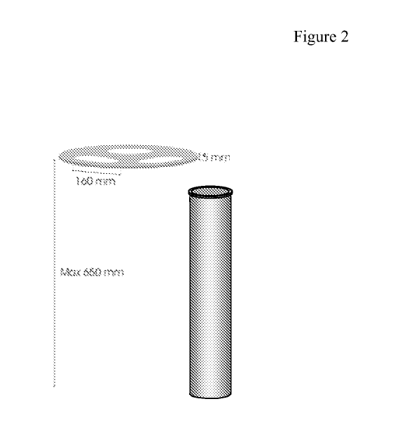

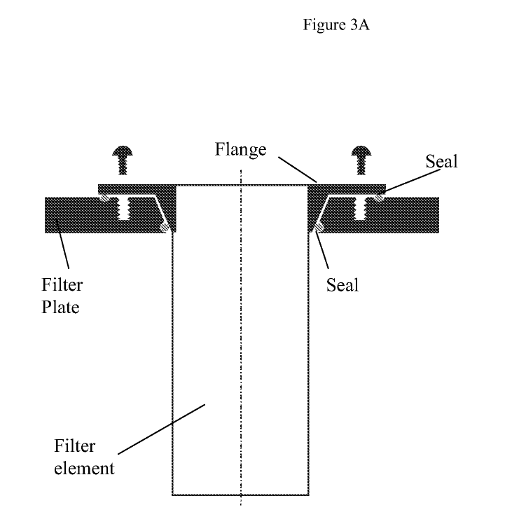

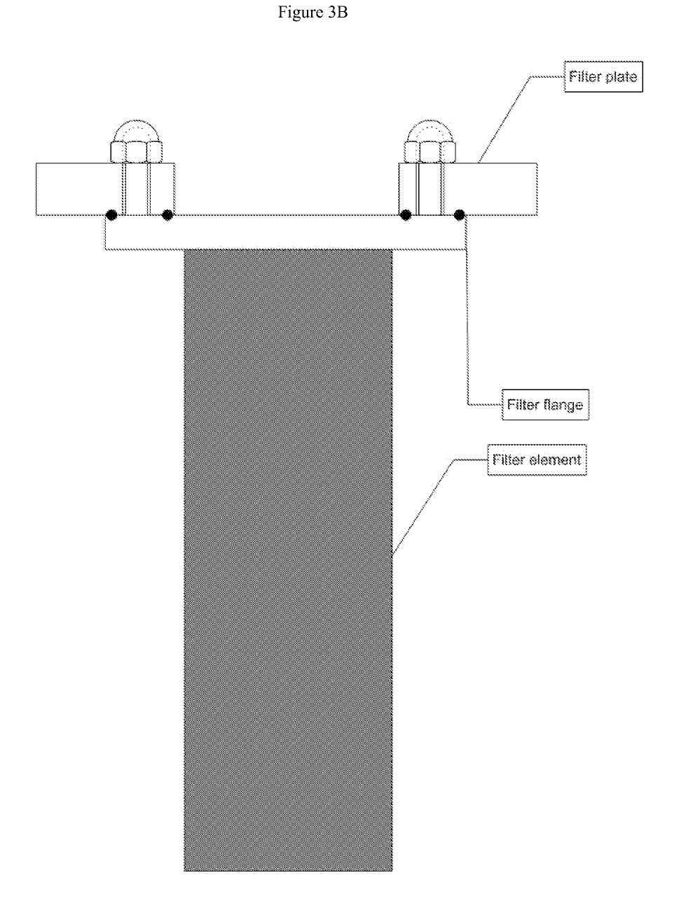

In a particular embodiment of the present invention, the filter elements are positioned within the housing of the filter assembly by means of a filter plate preferably positioned in the upper region of the filter assembly, said plate containing openings wherein the filter elements can be suspended (see for illustration FIG. 2). The filter elements are preferably removably attached to the filter plate by flanges, which allow good in situ cleaning The flanges preferably prevent spray-dried powder to get between the filter element and the filter plate. Therefore, the flanges comprise preferably one or more seals embedded in the filter plate or filter flange, said seals preferably being o-ring rubber seals. FIG. 3A shows an example of such a flange where the filter element is inserted in the filter plate from the top and where the filter element is fastened to the filter plate using screws or bolts. FIG. 3B shows another embodiment of a flange where the filter element is attached to the filter plate from the bottom and where the filter element is fastened to the filter plate using screw caps.

For use in a self-cleanable filter assembly, the filter plate has to be constructed to allow full drainability by their mechanical design.

It is considered to be within the skills of the person skilled in the art to determine the number of filter elements according to the need.

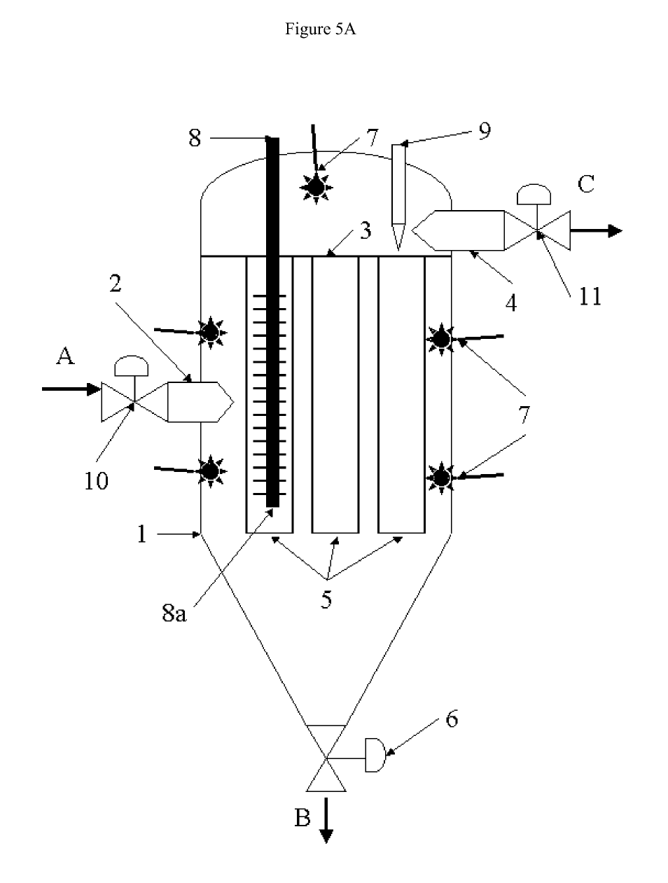

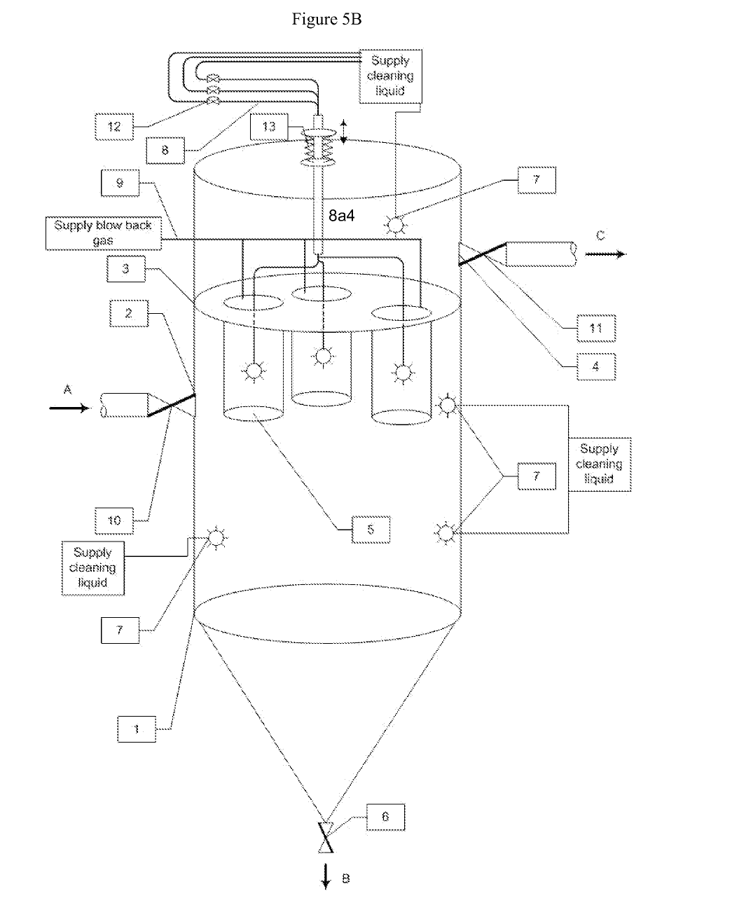

The present invention further relates to a self-cleanable (cleanable in place; cleanable in situ) filter assembly for filtering solid particles from a gas stream entering the filter assembly wherein the filter assembly contains at least one filter element, preferably a metal fiber filter element, more preferably a metal fiber filter element having a hollow interior, such as for example a tubular or cylindrical metal fiber filter element, wherein the filter element is positioned within the housing of the filter assembly such that the exterior of the filter element is in communication with the gas stream entering the filter chamber via the inlet and that the entering gas must pass through said filter element to reach the gas outlet. In particular, the present invention relates to a filter assembly for collecting and recovering spray-dried powder particles entrained in the outlet gas leaving the cyclone for use in a spray-dryer installation. Said filter assembly comprises one or more metal fiber filter elements, in particular stainless steel metal fiber filter elements, more in particular tubular or cylindrical metal fiber filter elements wherein the bottom of the filter element is also composed of metal fiber filter medium, and further comprising means for cleaning the one or more filter elements contained in said filter assembly. Said cleaning means have an outlet, preferably the outlet comprises spraying means, such as for example a spray nozzle, spray ball, spray lance, spray tube, positioned to introduce or spray cleaning liquid to the interior of the filter element. Preferably, the cleaning means are movable cleaning means, in particular cleaning means, which can move axially in the interior of the filter element during cleaning. Thus, the cleaning means can gradually move down or down and up in the interior of the filter element during cleaning A particular embodiment of a cleaning means of the present invention is a spray nozzle or spray ball connected to the end of a supply pipe for cleaning liquid which is movable (see also FIG. 5B). Another particular embodiment of a cleaning means is a spray lance or spray tube having spray points defined along the length of the lance or tube and being connected to the end of a supply pipe for cleaning liquid which is movable (see also FIG. 5A). Preferably, the cleaning means comprise a cleaning liquid supply pipe having a spray nozzle or spray ball connected at the end of the pipe. It is considered to be within the skills of the skilled person to recognize the most appropriate cleaning means for a particular filter assembly.

By using an axially movable cleaning means assembly, the impact force of the cleaning liquid is used over the whole length of the filter element without considerably increasing pressure on the assembly. Due to the important role of the impact force on the cleaning efficiency and the optimization of this force by the movable cleaning means, the used amount of cleaning liquid and the pressure on the assembly can be considerably reduced when compared with existing systems.

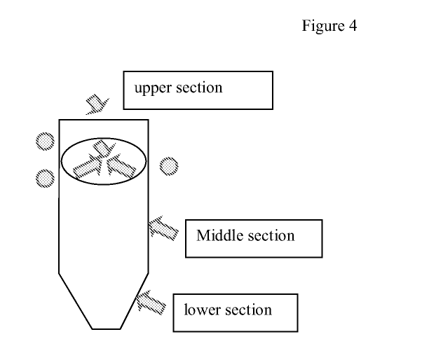

The cleaning means of the filter assembly may further comprise one or more, preferably a plurality, of cleaning means, for instance spray nozzles or spray balls, extending through the housing of the filter assembly. Said cleaning means are able to spray a cleaning liquid onto the exterior of the filter elements contained in the filter assembly and onto the interior surfaces of the filter assembly in order to provide good cleaning of the filter assembly and its filter elements. The cleaning means extending through the housing of the filter assembly are preferably placed in the middle section of the filter assembly, but they can also be placed at the lower section or at the upper section of the filter assembly. The type, number, and position of the spray nozzles or spray balls will be based on the specific shape of the filter assembly and the filter elements contained therein. The skilled man is understood to be able to choose the most appropriate spray nozzles or spray balls. The spray nozzles or spray balls extending through the housing of the filter assembly are preferably distributed around the circumference of the assembly as illustrated in FIG. 4 showing a circular header for 3 spraying means. It is to be understood that the number of spray nozzles or spray balls per circle may vary. More preferably, the filter assembly contains a plurality of spray nozzles extending through the housing of the middle section of the filter assembly at different circular locations, in one or more circular circuits. It is within the knowledge of the skilled man to recognize the number of spray nozzles or spray balls needed and the number of circular headers needed in order to provide for a sufficient in-place GMP cleaning of a particular filter assembly. The lower, middle and upper section of a filter assembly are indicated in FIGS. 4. A skilled man will easily recognize these sections. It is to be understood that the cleaning means can be connected with the clean-in-place kitchen and that a cleaning recipe can be programmed.

FIG. 5A shows an embodiment of the filter assembly of the present invention in vertical cross section. The filter assembly for filtering solid particles from a gas stream comprises a housing defining a filter chamber (1) in which a filter plate (3) is fixed. This filter plate is the support for the filter elements (5) (In FIG. 5A only 3 filter elements are depicted for clarity reasons, but it is to be understood that the number of filter elements may vary according to the need). Through the air inlet (2) the gas stream containing the powder particles (Arrow ‘A’) enters the assembly. The gas stream is filtered by the filter elements and leaves the assembly through the air outlet (4) as a clean gas (stream ‘C’). The powder can be collected at the bottom of the assembly, by using the bottom valve (6), resulting in the powder leaving the assembly (Stream ‘B’).

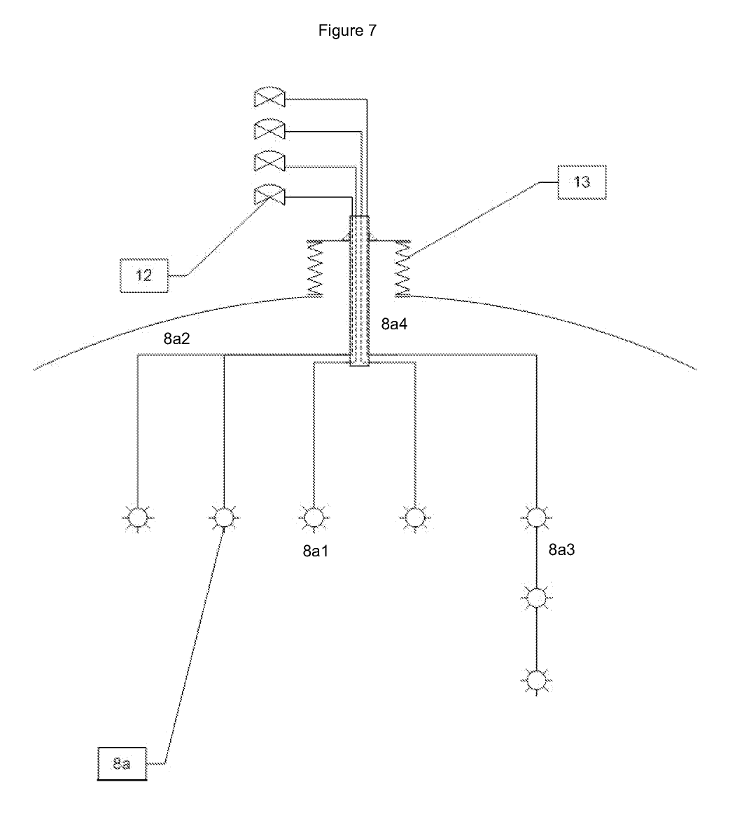

During cleaning, cleaning liquid is forced through the cleaning liquid supply pipe (8) containing at the end of the pipe a spray lance (8a), into the interior of the filter element to clean the filters from the inside and remove product deposit from the exterior of the filter elements (for clarity reasons, in FIG. 5A only one spray lance is depicted, but it is to be understood that preferably each filter element has a cleaning means). To increase the efficiency of the cleaning process, the cleaning means is preferably a movable cleaning means; the cleaning means can move axially in the interior of the filter element, thus maximizing cleaning by impact of the cleaning liquid. For an embodiment of providing a cleaning means which is movable in the interior of the filter element reference is made to FIG. 5B and FIG. 7.

Further cleaning of the filter assembly can be done using several spray nozzles or spray balls (7) extending through the housing of the filter assembly.

FIG. 5B shows a preferred embodiment of the filter assembly of the present invention in vertical cross section. The filter assembly for filtering solid particles from a gas stream comprises a housing defining a filter chamber (1) in which a filter plate (3) is fixed. This filter plate is the support for the filter elements (5) (In FIG. 5B only 3 filter elements are depicted for clarity reasons, but it is to be understood that the number of filter elements may vary according to the need). Through the air inlet (2) the gas stream containing the powder particles (Arrow ‘A’) enters the assembly. The gas stream is filtered by the filter elements and leaves the assembly through the air outlet (4) as a clean gas (stream ‘C). The powder can be collected at the bottom of the assembly, by using the bottom valve (6), resulting in the powder leaving the assembly (Stream ‘B’).

During cleaning, cleaning liquid is forced through the cleaning liquid supply pipe (8) containing at the end of the pipe a spray nozzle or spray ball (8a; FIG. 7), into the interior of the filter elements to clean the filters from the inside and remove product deposit from the exterior of the filter elements (in FIG. 5B, 3 filter elements (5) are depicted each containing in its interior a cleaning means comprising a spray nozzle or spray ball at the end of the cleaning liquid supply pipe). To increase efficiency of the cleaning process, the cleaning means can move axially in the interior of the filter element, thus maximizing cleaning by impact of the cleaning liquid. An embodiment of providing a cleaning means which is movable in the interior of the filter element is depicted in FIG. 5B and more in detail in FIG. 7 wherein a bellows (13) attached to the top of the filter assembly is depicted. This allows movement of the cleaning means inside the filter assembly and into the filter elements while maintaining the integrity of the filter assembly.

The bellows can be made from stainless steel, PTFE or other suitable material. The main cleaning liquid supply pipes can be used either separate or combined using separate valves (12) on each pipe. These valves are preferably located outside the assembly thus allowing the use of standard valves. Thus depending on the configuration of the cleaning assembly, the filter elements can be cleaned separately or in groups by combining different spray lances/spray nozzles/spray balls to one main liquid supply pipe. The cleaning liquid supply pipes entering the filter assembly are preferably grouped together in a limited number of pipes, more preferably one main pipe (8a4 in FIGS. 5B and 7), to avoid the occurrence of dead spots in the interior of the filter assembly, facilitating movement and allowing valve mechanisms to be installed outside the assembly. This approach increases cleaning efficiency and reduces consumption of cleaning liquid.

Inside the filter assembly, the supply pipes can be designed to bring water to one (8a1) or more (8a2) spray nozzles/ spray balls as depicted in FIG. 7. One cleaning liquid supply pipe extending in the interior of the filter element may also contain one or more (8a3) spray nozzles/spray balls. Further cleaning of the filter assembly can be done using several spray nozzles/spray balls (7) extending through the housing of the filter assembly.

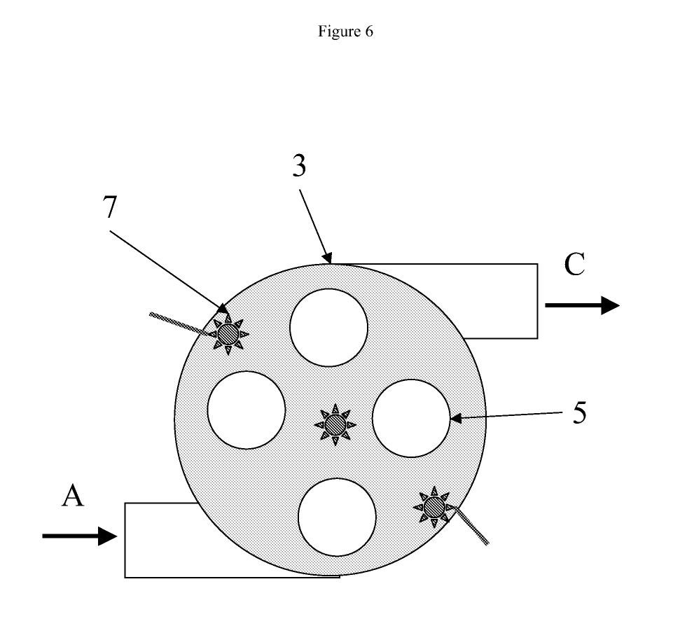

FIG. 6 shows a transverse cross section at the upper section, above the filter plate, of the filter assembly of FIGS. 5A and B. It shows an inlet with gas stream A, an outlet gas stream C, a filter plate (3) with openings for the filter elements (5) and spray nozzles/spray balls (7) for cleaning the upper part of the filter assembly.

During operation, process gas is forced through the assembly either by drawing air through the filter from the outlet or by pushing the gas stream through the filter from the inlet. The filter elements block the powder at their exterior surfaces and allow the gas stream to pass through. The powder on the filter elements is removed either by gravity or by pulsing clean gas through the filter element using the cleaning means for cleaning the interior of the filter elements, i.e. the spray lance (8) of FIG. 5A or the spray nozzles/spray balls (8a) of FIG. 7(5B)). Alternatively, a separate pipe configuration above or within the filter element suitable for passing gas through the filter element may be provided for this purpose, see (9) in FIGS. 5A and 5B. An example of such a pipe configuration is e.g. a pulse jet. This technique of removing deposits from the exterior of a filter element by passing gas through the filter element from the interior side is commonly known as ‘blow back’ and the gas pipe configuration is commonly known as a back flow gas supply pipe. Preferably, the clean gas is pulsed through the filter element by using a separate back flow gas supply pipe (9). e.g. a separate pulse jet. This enables one to optimize the gas supply pipe for blow back and to optimize the cleaning means for cleaning An exemplary configuration of a separate back flow gas supply pipe and a separate cleaning liquid supply pipe is a configuration wherein the cleaning liquid supply pipe is located axially or coaxially within the back blow gas supply pipe. Another exemplary configuration of a separate back flow gas supply pipe and a separate cleaning liquid supply pipe is a configuration as depicted in FIGS. 5A and 5B wherein the two pipes are located next to each other and not within each other.

At any time during operation, powder can be collected at the bottom using the bottom valve, without interfering with the filtration process.

During cleaning, cleaning liquid (i.e. water, solvents or detergent mixture) is forced through the cleaning means (8 and 8a of FIGS. 5A, 5B and 7) to allow thorough cleaning of the filter elements both by the effect of the cleaning liquid as well as by the impact force of the cleaning liquid on the element. By cleaning the filter elements from the ‘clean’ side to the ‘dirty’ side, in casu from the interior of the filter element to the exterior of the filter element, forcing of small particles from the outer surface further inside the filter material, as can be seen in other designs, is avoided. Due to the impact force of the cleaning liquid, it penetrates the filter and drains from the outside of the filter element. The axial movement of the cleaning means in the interior of the filter element enables that the impact force of the cleaning liquid is used over the whole length of the filter element without considerably increasing pressure on the filter assembly. Due to the important role of the impact force of the cleaning liquid on the cleaning efficiency and the optimization of this force by the movable cleaning means, the used amount of cleaning liquid can be considerably reduced when compared with existing systems.

Liquid inside the filter elements drains through the walls of the filter and the permeable bottom of the filter element, which is composed of the same filter material.

It is to be understood that the movable cleaning means is designed such as to avoid the occurrence of dead spots (locations which can not appropriately be cleaned because they are difficult to reach). Therefore, it is considered to be within the skill of the skilled person to recognize the most appropriate movement of the cleaning means and the most appropriate cleaning means, e.g. spray nozzle or spray ball or lance, in order to obtain the most efficient cleaning process depending on the characteristics of the filter assembly. For instance, efficient cleaning of a long filter element will require a deeper movement of the cleaning means in the interior of the filter element when compared to a shorter filter element. This can be accomplished by allowing a longer movement distance of the cleaning means or by using more than one spray ball or nozzle on the cleaning liquid supply pipe (8a3, FIG. 7). The latter allows cleaning of the filter element while limiting the movement distance of the cleaning means and thus reducing the need for free space at the top part of the filter assembly.

After cleaning of the filter elements, the assembly can be further cleaned using spray nozzles or spray balls extending through the filter assembly (7). This can be followed again by a cleaning cycle of the filter elements. The order of cleaning filter elements and assembly and the determination of the number of required cleaning cycles is within the skills of the skilled person. After several rinses with cleaning liquid, drying is started by blowing hot air through the spray lances/spray nozzles. To force the air through the filter material, inlet valve (10) (FIGS. 5a and B) and outlet valve (11) (FIGS. 5A and B) can be closed which allows a slight pressure build up in the top of the assembly. This puts a uniform load on the filter elements to avoid structural damage and assure an even drying.

Drainage of the whole assembly will be through the bottom valve.

The present invention further relates to a system for cleaning the filter assembly according to the present invention, said system comprising cleaning means having an outlet positioned to introduce, e.g. spray, a cleaning liquid to the hollow interior of the filter element, and optionally one or more, preferably a plurality, of further cleaning means extending through the housing of the filter assembly, means for pumping cleaning solution to said cleaning means for application in the filter assembly, means for selectively communicating cleaning liquid between the pumping means and the cleaning means, and means for automatically controlling the operation of the cleaning system. Preferably, the system comprises cleaning means having an outlet positioned to introduce, e.g. spray, cleaning liquid to the hollow interior of the filter element characterized in that the cleaning means can move axially in the interior of the filter element during cleaning The present invention also relates to the use of the above system for cleaning the filter assembly. The present invention also relates to a filter assembly as described hereinabove wherein the filter assembly further comprises means for pumping cleaning liquid to the cleaning means for application in the filter assembly, means for selectively communicating cleaning liquid between the pumping means and the cleaning means, and means for automatically controlling the operation of the cleaning system.

The present invention also relates to a spray dryer installation comprising a filter assembly as described hereinabove or comprising a cleaning system as described hereinabove.

The present invention further relates to a method of cleaning the one or more filter elements of a filter assembly as described hereinabove or a method of cleaning the filter assembly as described hereinabove, said method comprising the steps of

a. introducing, preferably spraying, a cleaning liquid from the cleaning means into the interior of the filter element; optionally followed by spraying a cleaning liquid from the cleaning means extending through the housing of the filter assembly;
b. stopping the flow of cleaning solution to said cleaning means;
c. allowing the filter elements to dry.

The cleaning liquid employed under a. can be water, or an alkali detergent solution, or an acid detergent solution or an organic solvent mix of said different cleaning liquids can be used sequentially, the one after the other. This implies that the spraying of the cleaning liquid under a. can involve several spraying cycles, such as for example first spraying water, followed by spraying an alkali detergent solution, followed by spraying again water for rinsing, followed by spraying an acid detergent solution, followed by spraying again water for rinsing. The drying step under c. can be performed by circulating hot air in the system by building up a slight pressure in the top of the assembly. Systems for applying hot air and pressure are known to the skilled man and it is considered to be within his skills to recognize how to install them in the present filter assembly.

### Resistance to Cleaning Solutions

As indicated above, a preferred embodiment of the present metal fiber filters are stainless steel metal fiber filters. It was tested whether detergents used during a cleaning procedure may have a corrosive effect on the metal wires. The wires have a large surface, which may be subject to corrosion. Therefore, an experiment was performed in which a sample of the Bekiflow®-material was put in contact with cleaning detergents. A logical experiment would be to simulate a cleaning-procedure (incl. rinsing, different detergent, drying, . . . ), but it was decided to test the sample under stress conditions, i.e. by putting the material in contact with the detergent with the most corrosive action for an extended period of time (several hours or days where normally 15 minutes contact time is used during normal cleaning)

### Experiment 1

### Alkali Stress Conditions at Room Temperature

### Composition of Alkali-detergent-solution:

1.2% (v/v) Cosa CIP 92 (Henkel)

0.8% (v/v) Cosa PUR 84 (Henkel)

### Method

A mixture of 1.2 ml Cosa CIP 92+0.8 ml Cosa PUR 84 was diluted with demineralised water until 100 ml.

A piece of Bekiflow®-material (25×50 mm) was brought in contact with the detergent-solution for the time specified in the below table. Observations via stereo-microscopy were performed at the specified time-point to observe corrosion.

| | time | Observation |
|---|---|---|
| 1 | t = 0 | Clean, new filter at start |
| 2 | t = 15 min | No change observed |
| 3 | t = 45 min | No change observed |
| 4 | t = 1 h 15 min | No change observed |
| 5 | t = 3 h 45 min | No change observed |
| 6 | t = 5 h 45 min | No change observed |
| 7 | t = 22 h | No change observed |
| 8 | t = 29 h | No change observed |

### Results

Even after an extended (abnormal) contact-time of 29 hours no corrosion was observed.

### Experiment 2

### Alkali Stress Conditions at 70° C.

### Composition of Alkali-detergent-solutions:

1.2% (v/v) Cosa CIP 92 (Henkel)

0.8% (v/v) Cosa PUR 84 (Henkel)

### Method

A mixture of 1.2 ml Cosa CIP 92+0.8 ml Cosa PUR 84 was diluted with demineralised water until 100 ml.

A water-bath was installed at 70° C. A piece of Bekiflow®-material (20×50 mm) was brought in contact with the detergent-solution and was placed in the water bath.

Observations via stereo-microscopy were performed at the specified time-point in the below Table to observe corrosion.

| | time | Observation |
|---|---|---|
| 1 | t = 0 | Clean, new filter at start |
| 2 | t = 30 min | No change observed |
| 3 | t = 1 h | No change observed |
| 4 | t = 2 h | No change observed |
| 5 | t = 4 h | No change observed |
| 6 | t = 6 h | No change observed |
| 7 | t = 7 h | No change observed |

### Results:

After 7 hours of contact-time at 70° C. (which is approx 30 times longer than the normal contact time (15 min) during a normal cleaning procedure) no corrosion was observed.

It is to be understood that the foregoing is considered as illustrative only of the principles of the invention. Further, numerous modifications and changes will readily occur to those skilled in the art, it is not desired to limit the invention to the exact construction and operation shown and described herein, and, accordingly, all suitable modifications and equivalents may be resorted to, falling within the scope of the invention; the present invention may be embodied in various forms. Therefore, specific details disclosed herein are a representative basis for teaching one skilled in the art to employ the present invention in virtually any appropriately detailed system, structure or manner. Therefore, the present filter assembly must not be considered to be restricted for use in a spray dryer installation. The filter assembly can be implemented in any installation where filtering of solid particles from a gas stream is desired. It also has to be understood that terms such as filter elements also include filter cartridges or filter bags.

1. A filter assembly for filtering solid particles from a gas stream entering the filter assembly comprising a housing defining a filter chamber and comprising a gas inlet and a gas outlet;
at least one metal fiber filter element having a hollow interior and being positioned within the housing such that the exterior of the filter element is in communication with the gas stream entering the filter chamber via the inlet and that the entering gas must pass through said filter element to reach the gas outlet; and
at least one cleaning means having an outlet positioned to introduce a cleaning liquid to the interior of the filter element,
characterized in that the cleaning means can move axially in the interior of the filter element during cleaning

2. A filter assembly according to claim 1 comprising more than one filter element and more than one cleaning means.

3. A filter assembly according to claim 1 wherein the metal fiber filter element is a stainless steel metal fiber filter element.

4. A filter assembly according to claim 3 wherein the stainless steel metal fiber filter element is a stainless steel sintered metal fiber filter element.

5. A filter assembly according to claim 1 wherein the filter element is able to retain particles with an average particle size of about 0.2 micrometer.

6. A filter assembly according to claim 1 wherein the filter element comprises metal fiber filter medium at the bottom of the filter.

7. A filter assembly according to claim 1 wherein the filter element is a cylindrical filter element.

8. A filter assembly according to claim 1 wherein the filter assembly comprises further cleaning means extending through the housing of the filter assembly.

9. A filter assembly according to claim 8 wherein the further cleaning means comprise a plurality of spray nozzles or spray balls positioned in one or more circular circuits in the housing of the filter assembly.

10. A filter assembly according to claim 8 wherein the further cleaning means are extending through the housing of the filter assembly in the middle section, the lower section or the upper section of the filter assembly or any combination of said sections.

11. A filter assembly according to claim 1 wherein the movable cleaning means comprises a spray nozzle or spray ball connected to the end of a supply pipe for cleaning liquid.

12. A filter assembly according to claim 1 wherein the movable cleaning means comprises a bellows.

13. A filter assembly according to claim 12 wherein the bellows is connected to the top of the filter assembly.

14. A filter assembly according to claim 1 further comprising a back flow gas supply pipe above or within the filter element.

15. A filter assembly according to claim 1 wherein the filter assembly further comprises means for pumping cleaning liquid to the cleaning means for application in the filter assembly, means for selectively communicating cleaning liquid between the pumping means and the cleaning means, and means for automatically controlling the operation of the cleaning system.

16. A filter assembly according to claim 1 suitable for filtering solid particles having an average particle size ranging from about 0.2 micrometer to about 10 micrometer from a gas stream.

17. A filter assembly according to claim 1 wherein the solid particles comprise an active pharmaceutical ingredient.

18. A spray dryer installation comprising a filter assembly according to claim 1.

19. A method of cleaning the filter assembly according to claim 1, said method comprising the steps of
a. introducing a cleaning liquid from the cleaning means into the interior of the filter element; optionally followed by spraying a cleaning liquid from the cleaning means extending through the housing of the filter assembly;
b. stopping the flow of cleaning solution to said cleaning means;
c. allowing the filter elements to dry.
